(19) United States
(12) Patent Application Publication
(10) Pub. No.: US 2005/0286352 A1
(43) Pub. Date: Dec. 29, 2005

(54) Lens driving unit

(76) Inventor: Toshiharu Inui, Toufu-machi (JP)

Correspondence Address: EDWARDS & ANGELL, LLP, P.O. BOX 55874, BOSTON, MA, 02205, US

(21) Appl. No.: 11/166,911

(22) Filed: Jun. 23, 2005

(30) Foreign Application Priority Data
Jun. 25, 2004 (JP) P2004-187663

(51) Int. Cl. G11B 7/00

(52) U.S. Cl. 369/44.11; 369/44.14

(57) ABSTRACT

In a lens driving unit, when a first lens group holder 10 has received an impact from external in a use state in which first, second lens group holders 10, 11 are projecting, the first lens group holder 10 and the first nut 16 are released from their coupling by attractive force of a magnet 18. Then, the first lens group holder 10 is moved toward one side opposite to the subject side. Thus, with a cushioning member 20 brought into contact with a second lens group holder 11, the second lens group holder 11 and the second nut 17 are released from their coupling by attractive force of a magnet 19, and the first, second lens group holders 10, 11 are moved toward one side opposite to the subject side. As a result, the lens group holders 10, 11 instantaneously come into a collapsed state, by which the impact is relaxed so that damage of the lens barrel portion or the like is reduced, while a miniaturization of the lens driving unit in the optical axis direction can be achieved. Moreover, cushioning members 20, 21 relax the impact due to collisions among component parts to reduce damage.

### CROSS-REFERENCE TO RELATED APPLICATIONS

This nonprovisional application claims priority based on Application No. 2004-187663 filed on Jun. 25, 2004 in Japan under 35 U.S.C. sctn.119(a), the entirety of which is incorporated herein by this reference.

### BACKGROUND OF THE INVENTION

The present invention relates to a lens driving unit for performing zooming or auto-focus operations by moving the lens along the optical axis direction.

Generally, there have been adopted compact cameras or digital cameras or the like that can be miniaturized in the optical axis direction by virtue of adopting a so-called collapsible lens construction that a plurality of lens holders, which hold the lens, are projected from the camera body so as to enable zooming operation during the use of the camera and the lens holders are accommodated in the camera body during non-use of the camera.

However, in cameras adopting the collapsible lens type construction, there is a problem that because of the projection of the lens holders from the body during the use of the camera, a fall of the camera in that state would cause the drive mechanism including the lens holders to be damaged with large possibility particularly upon such an impact that the projecting lens holders may receive directly from external.

Therefore, there has been proposed a lens driving unit which absorbs and relaxes the impact due to a fall or the like to reduce the possibility of damage of the lens holders or drive mechanism (see JP 2003-131109 A). This lens driving unit is composed of a lead screw rotationally driven by a drive source, a nut to be screwed with the lead screw, a lens frame for holding the lens, and a coil spring for making the lens frame biased outward in the optical axis direction (toward the drive source) to bring the lens frame into contact with the nut, where the lens frame is made movable in the optical axis direction. In this construction, the lens frame is kept always in contact with the nut by the biasing force of the coil spring. In this state, when an impact is applied to the lens frame from external due to a fall or the like, the lens frame moves against the elastic force of the coil spring to separate from the nut, thereby absorbing and relaxing the impact. Thus, the possibility of damage of the lens driving mechanism can be reduced.

However, the above described lens driving mechanism has a problem shown below. That is, the lens frame that holds the lens is kept always in contact with the nut by the biasing means implemented by the coil spring. Accordingly, when the lens frame is moved in a direction in which the coil spring expands (i.e., an outward direction along the optical axis), the driving torque required for the drive-source motor is small because the biasing force of the coil spring gradually decreases. On the other hand, when the lens frame is moved in a direction in which the coil spring contracts (i.e., an inward direction along the optical axis), the driving torque required for the motor is large because the biasing force of the coil spring gradually increases.

In the case where the motor is an electromagnetic DC motor, the operation becomes unstable with increasing load as described above, making it necessary to increase the supply current to the DC motor for generation of the required torque. Further, in the case where the motor is a stepping motor, there is a possibility that the increase in load may cause occurrence of step out due to idling of the motor.

Further, since the coil spring differs in state depending on the position of the lens frame even during the move in one identical direction, there occur variations in the load to the motor. That is, the torque required for the motor to drive the lens frame within the move range varies at all times. This poses a problem that the control for precisely moving the lens with high precision becomes harder to exert during zooming or autofocusing operation. Since the contact pressure between the lens frame and the nut differs depending on the position of the lens frame, there is another problem that the state of impact absorption against any external impact differs depending on

Further, in a case of a lens driving unit having a high-power zooming function, it is necessary to set a large move distance of the lens. In this case, as the move distance of the lens becomes larger, the biasing means needs to be formed larger in linkage, making it even harder to achieve a downsizing in the lens optical-axis direction.

Further, the necessity of bringing the lens frame into contact with one side of the nut leads to a double structure of a lens-frame side contact portion with the nut and a nut side contact portion with the lens frame, so that the lead screw to be rotationally driven by the drive source becomes longer toward the axial direction. Thus, the lens driving unit becomes even harder to downsize in the optical axis direction.

Also, when external force is applied to the lens frame, the impact is absorbed and relaxed by the elasticity of the coil spring that is a biasing means. However, the lens frame is normally under the force of restoration in the projecting direction against the body by the coil spring. Therefore, indeed it is less likely that the coupling portion of the lens frame and the nut is damaged, but there is a fear that other portions such as the barrel portion of the lens frame may be damaged because the lens frame never comes to rest in a completely collapsed and sunk state.

### SUMMARY OF THE INVENTION

Accordingly, an object of the present invention is to provide a lens driving unit which has an impact-resistant structure against external force to the lens or lens holders and which is downsizable in the lens optical-axis direction.

In order to achieve the above object, there is provided a lens driving unit comprising:

a lens holder which holds a lens and which is movable in an optical axis direction of the lens;

lens holder driving means which is to be removably coupled with the lens holder by an attractive force that acts in proportion to its distance to the lens holder as the distance to the lens holder becomes smaller than a specified distance, so that the lens holder is translated in the lens optical axis direction, and which is released from coupling with the lens holder by the attractive force when an impact in the optical axis direction is applied to the lens holder in a state of being coupled with the lens holder; and

coupling control means for moving the lens holder driving means, which has been released from the coupling with the lens holder because of the impact, to a position that allows the lens holder driving means to be coupled with the lens holder by the attractive force, and for making the lens holder and the lens holder driving means coupled with each other.

With this constitution, in the use mode, the lens holder and the lens holder driving means are removably coupled with each other by the attractive force, and the lens holder is translated by the lens holder driving means to a specified position in the lens optical axis direction. In this state, when an impact in the optical axis direction is applied to the lens holder, the coupling with the lens holder driving means by the attractive force is canceled, where the lens holder moves in the optical axis direction to come into a collapsed state. Accordingly, the lens holder is enabled to move so as to instantaneously come into a collapsed state upon reception of external force, no matter which position it is placed. Thus, it is implementable to relax the impact and reduce the damage.

Further, in a reuse mode, the lens holder driving means is moved by the coupling control means to a position where the lens holder driving means can be coupled with the lens holder, and the lens holder and the lens holder driving means are coupled with each other. Thus, the lens holder and the lens holder driving means, which have been separated from each other upon the impact, can be removably coupled with simplicity.

In one embodiment of the present invention, the lens holder driving means comprises:

a lead screw which extends in the lens optical axis direction and which has a rotating shaft parallel to the optical axis;

a drive source for driving the lead screw into rotation; and

a nut which is to be screwed with the lead screw and which is regulated for rotation,

wherein the lens holder and the nut have mutually opposing surfaces, and the surface of the lens holder and the surface of the nut are to be removably coupled with each other by the attractive force.

In this embodiment, the lens holder driving means can be made up so as to be operable with high precision with a simple construction.

In one embodiment of the present invention, the attractive force that causes the lens holder and the lens holder driving means to be coupled with each other is a magnetic attractive force.

According to this embodiment, the lens holder and the lens holder driving means can be removably coupled with each other with reliability in the use mode, the coupling between the lens holder and the lens holder driving means can be canceled promptly upon an impact, and the lens holder and the lens holder driving means that have separated from each other can be removably coupled with each other simply and promptly in the reuse mode.

In one embodiment od the present invention, the nut is made of a magnetic material,

a magnet is provided on a surface of the lens holder opposing the surface of the nut;

the lens holder and the nut are to be removably coupled with each other by a magnetic attractive force.

According to this embodiment, the nut to be screwed with the lead screw is formed of magnetic material, by which the lens holder driving means can be formed with the most simplicity and low cost. Further, even if the coupling surface of the lens holder with the nut and the coupling surface of the nut with the lens holder are twisted with each other, it is yet possible to obtain a drivable coupling in the twisted state. Accordingly, a high workability of assembly can be obtained.

In one embodiment of the present invention, the mutually opposing surfaces of the lens holder and the nut are formed within a plane perpendicular to the lens optical axis direction, and

the nut is placed on a subject side relative to the lens holder in the optical axis direction.

According to this embodiment, when the lens holder has received an impact from external, the nut does not move because of being screwed with the lead screw, but the lens holder is enabled to retreat toward one side of the nut opposite to the subject side. Therefore, the possibility of damage of the lens holder or the lens holder driving means can be reduced.

In one embodiment of the present invention, the mutually opposing surfaces of the lens holder and the nut are formed within a plane parallel to the lens optical axis direction, and

the surface of the lens holder and the surface of the nut, which are opposing to each other, are generally equal in length in the optical axis direction.

According to this embodiment, the mutually opposing surfaces of the lens holder and the nut are formed within a plane parallel to the lens optical axis direction. Therefore, it never occurs that the contact portion of the lens holder with the nut and the contact portion of the nut with the lens holder are formed in a double structure in the optical axis direction. Thus, the coupling portions can be formed most compactly by forming the mutually opposing surfaces of the lens holder and the nut generally equal in length In the optical axis direction to each other. As a result, a miniaturization of the lens driving unit in the optical axis direction can be achieved.

In one embodiment of the present invention, the mutually opposing surfaces of the lens holder and the nut are placed with a specified distance therebetween.

According to this embodiment, when the lens holder and the nut are restored to the original state from a decoupled and mutually separated state, a smooth coupling operation can be achieved without causing their mutual contact.

In one embodiment of the present invention, at a start of an operation mode, the lens holder is moved to a home position by the lens holder driving means while the lens holder and the lens holder driving means are removably coupled with each other by the attractive force,

in a use mode, the lens holder is moved to a use position by the lens holder driving means while the lens holder and the lens holder driving means are removably coupled with each other by the attractive force;

when an impact is applied to the lens holder in the optical axis direction, the lens holder and the lens holder driving means are released from their coupling due to the attractive force, and the lens holder is moved in the optical axis direction so as to come into a collapsed state; and

in a reuse mode, the lens holder driving means is moved by the coupling control means to a position where the lens holder driving means can be coupled with the lens holder by the attractive force, and the lens holder and the lens holder driving means are coupled with each other again.

According to this embodiment, in the use mode, the lens holder and the lens holder driving means are removably coupled with each other by the attractive force, and the lens holder is translated by the lens holder driving means to a specified position in the lens optical axis direction. In this state, when an impact in the optical axis direction is applied to the lens holder, the coupling with the lens holder driving means by the attractive force is canceled, where the lens holder moves in the optical axis direction to come into a collapsed state. Accordingly, the lens holder is enabled to move so as to instantaneously come into a collapsed state upon reception of external force, no matter which position it is placed. Thus, it is implementable to relax the impact and reduce the damage.

Further, in the reuse mode, the lens holder driving means is moved by the coupling control means to a position where the lens holder driving means can be coupled with the lens holder, and the lens holder and the lens holder driving means are coupled with each other. Thus, the lens holder and the lens holder driving means, which have separated from each other upon the impact, can be removably coupled with each other simply.

As apparent from the above description, in the lens driving unit of the present invention, when the distance between the lens holder and the lens holder driving means has become smaller than a specified distance, the lens holder and the lens holder driving means are removably coupled with each other by an attractive force that acts in proportion to the above distance. Therefore, when an impact in the optical axis direction is applied to the lens holder, the lens holder is enabled to move so as to instantaneously come into a collapsed state, no matter which position it is placed, so that the impact can be relaxed and the damage can be reduced. Further, in the reuse mode, since the lens holder driving means is moved by the coupling control means to a position where the lens holder driving means can be coupled with the lens holder, the lens holder and the lens holder driving means, which have separated from each other upon the impact, can be removably coupled with each other simply.

Moreover, there is no need for any biasing means such as spring for biasing the lens holder against the lens holder driving means. Therefore, there is no possibility that the torque required for the motor serving as the lens holder driving means may vary, so that the lenses can be precisely moved with high precision in the zooming or autofocusing operation.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a plan view of a lens driving unit according to the present invention;

FIG. 2 is a sectional view at A-H of FIG. 1;

FIG. 3 is a sectional view at A-H of FIG. 1 in a state that the lens group holder is projecting from the lens driving unit;

FIG. 4 is a sectional view at A-H of FIG. 1 in a state that the lens group holder has collapsed;

FIGS. 5A and 5B are a plan view and a sectional view, respectively, of the first lens group holder;

FIGS. 6A and 6B are a plan view and a sectional view, respectively, of a second lens group holder;

FIG. 7 is a flowchart of lens drive control operation;

FIG. 8 is a plan view of a lens driving unit other than that of FIG. 1;

FIG. 9 is a sectional view at I-P of FIG. 8;

FIG. 10 is a sectional view at I-P of FIG. 8 in a state that the lens group holder is projecting from the lens driving unit;

FIG. 11 is a sectional view at I-P of FIG. 8 in a state that the lens group holder has collapsed;

FIGS. 12A and 12B are a plan view and a sectional view, respectively, of the first lens group holder of FIG. 8; and

FIGS. 13A and 13B are a plan view and a sectional view, respectively, of the second lens group holder of FIG. 8.

### DETAILED DESCRIPTION OF THE PREFERRED EMBODIMENTS

Hereinbelow, the present invention is described in detail by embodiments thereof illustrated in the accompanying drawings.

### First Embodiment

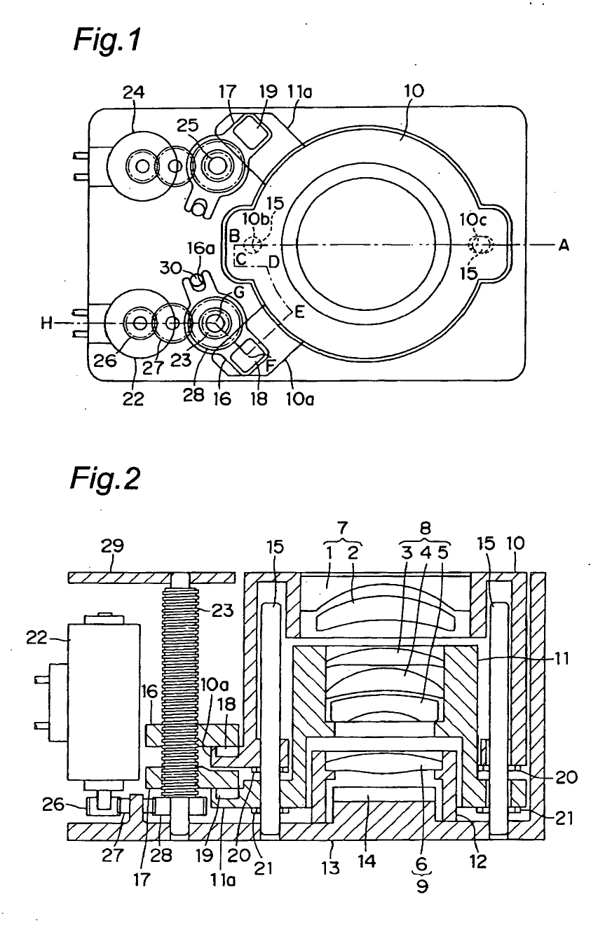

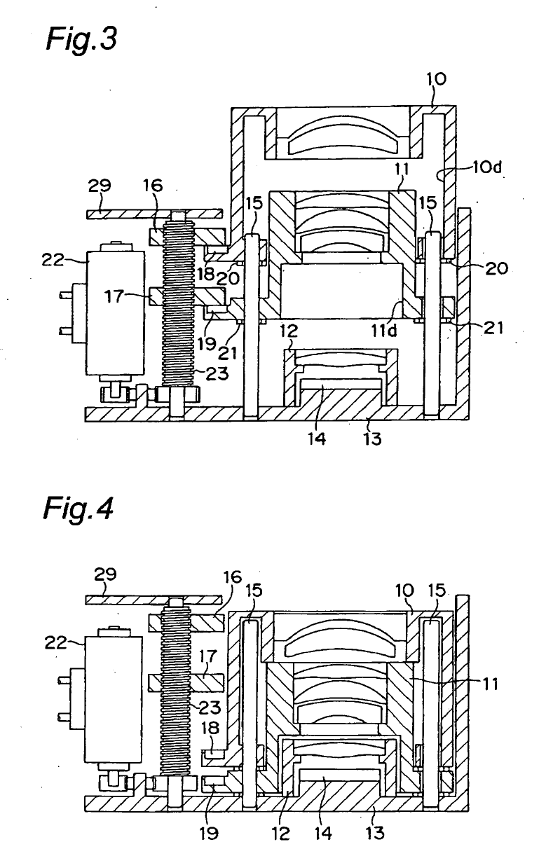

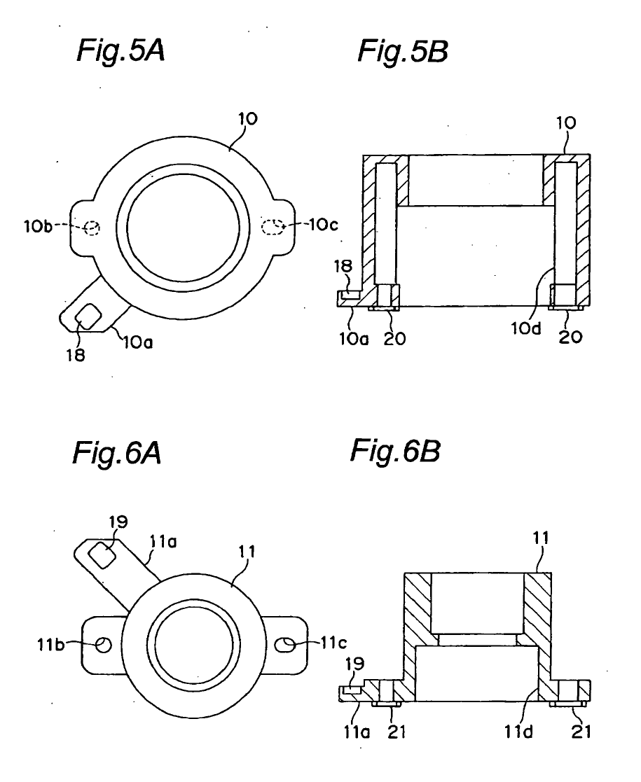

FIG. 1 is a plan view of a lens driving unit according to this embodiment. FIG. 2 is a sectional view at A-H of FIG. 1. FIG. 3 is a sectional view at A-H of FIG. 1 in a state that the lens group holder is projecting from the lens driving unit. FIG. 4 is a sectional view at A-H of FIG. 1 in a state that the lens group holder has collapsed with the lens group holder and the nut separated from each other. FIGS. 5A and 5B are a plan view and a sectional view, respectively, of a first lens group holder. FIGS. 6A and 6B are a plan view and a sectional view, respectively, of a second lens group holder.

This lens driving unit is composed of at least one lens group formed of a combination of a plurality of lenses, a drive mechanism section for driving the lens group, and a CCD sensor serving as an image pickup device, and the lens driving unit is to be mounted on a digital camera or portable telephone or the like as an image pickup module. The lens driving unit is so designed that a plurality of lens groups moved along the optical axis direction of the lenses so as to make the individual lens groups disposed at specified intervals, thus making it possible to variably optically zoom subjects. This makes it possible to shoot over wide ranges from wide angle photography to telephotography.

The lens driving unit given by way of example in this embodiment is a CCD camera module to be mounted on portable telephones, and has a lens construction capable of optical 3:1 zoom. Generally, as the zooming power goes higher, the distance over which the lenses are moved goes larger, where the lens driving unit becomes harder to downsize. On the contrary, lens driving units having, specifications for mounting on portable telephones in particular should preferably be small-sized units that are small in thickness in the optical axis direction.

As shown in FIGS. 2 to 4, with regard to six unit lenses 1-6 formed on an aspheric surface, the first lens 1 and the second lens 2 constitute a first lens group 7, the third lens 3, the fourth lens 4 and the fifth lens 5 constitute a second lens group 8, and the sixth lens 6 alone constitutes a third lens group 9. Then, the first lens group 7, the second lens group 8 and the third lens group 9 are fixed and held together to a lens group holder by ultraviolet curing type adhesion or the like.

The first lens group holder 10 that holds the first lens group 7 and the second lens group holder 11 that holds the second lens group 8 are both placed so as to be movable in the lens optical axis direction. In contrast to this, the third lens group holder 12 that holds the third lens group 9 is fixedly placed at a base portion 13 of the lens driving unit. The individual lens group holders 10 to 12 are formed of resin material in consideration of lighter weight, higher rigidity and lower cost. In particular, the first lens group holder 10 and the second lens group holder 11, both of which are made movable, are formed of, for example, polycarbonate base resin material excellent in sliding characteristic.

On the base portion 13 and between the base portion 13 and the third lens group 9 is fixedly placed a board-like CCD sensor 14 which is an image pickup device. In this case, the CCD sensor 14 is so positioned that its center is generally aligned with the optical axis of the lens groups 7-9.

Also on the base portion 13, two guide shafts 15 that serve as guides for moving the first lens group 7 and the second lens group 8 in the optical axis direction are erected at high accuracy so that their axes become parallel to the optical axis of the lenses. One of the two guide shafts 15 is inserted into round hole portions 10b, 11b formed at one-side end portions of the first lens group holder 10 and the second lens group holder 11. The other one guide shaft 15 is inserted into elongate hole portions 10c, 11c formed at the other-side end portions of the first lens group holder 10 and the second lens group holder 11 with a view to anti-rotation locking. The guide shafts 15 are desirably formed with high machining precision in outside dimensions, and generally, SUS materials or ceramic materials or the like are suitable as their material.

With this constitution, the first lens group 7 and the second lens group 8 are enabled to move independently in the optical axis direction while being held on the their lens group holders 10, 11. It is noted here that the first lens group 7 side is regarded as the subject side in the optical axis direction, and so the first lens group 7 side is expressed as the subject side.

On one side of the second lens group holder 11 opposite to the subject side is formed an excavation 11d which allows the third lens group holder 12 to be contactlessly accommodated therein in a collapsed state that the lens groups 7 to 9 come closer to one another (a state of FIG. 4). Similarly, on one side of the first lens group holder 10 opposite to the subject side is formed an excavation 10d which allows the second lens group holder 11 to be accommodated therein contactlessly in the collapsed state. Accordingly, when the lens driving unit is in a collapsed state, all the lens group holders 10 to 12 can be disposed within the height of the lens driving unit without any contact thereamong as shown in FIG. 4.

The first lens group holder 10 and the second lens group holder 11, both of which are formed generally cylindrical, have protrusions 10a, 11a which are formed on their outer peripheries for coupling with a later-detailed drive mechanism section. Then, magnets 18, 19 that are removably coupled with nuts 16, 17 on the drive mechanism section side by magnetic attractive force are fixed on the subject side of the protrusions 10a, 11a by means of adhesion or the like. Further, cushioning members 20, 21 each formed into a toroidal shape for impact absorption are provided on the surface opposite to the subject side at places which correspond to the round hole 10b, 11b and the elongate hole 10c, 11c formed in the first lens group holder 10 and the second lens group holder 11. Material of these cushioning members 20, 21, which is not particularly specified, may be rubber-base material or felt-base material, having only to be attachable to the lens group holders 10, 11 by adhesion or the like.

Next, the makeup of the drive mechanism section is explained. This drive mechanism section is composed of a first drive mechanism section for driving the first lens group holder 10, and a second drive mechanism section for driving the second lens group holder 11, where the first drive mechanism section and the second drive mechanism section operate independently of each other.

The first drive mechanism section is made up of a first motor 22 which serves as a drive source for the first lens group holder 10, a first nut 16 which is to be coupled with the protrusion 10a of the first lens group holder 10 by magnetic attractive force, a first lead screw 23 which is to be screwed with the first nut 16 to move the first nut 16 in the optical axis direction, and a first gear reduction part which makes the first motor 22 and the first lead screw 23 mechanically coupled with each other. Similarly, the second drive mechanism section is made up of a second motor 24 which serves as a drive source for the second lens group holder 11, a second nut 17 which is to be coupled with the protrusion 11a of the second lens group holder 11 by magnetic attractive force, a second lead screw 25 which is to be screwed with the second nut 17 to move the second nut 17 in the optical axis direction, and a second gear reduction part which makes the second motor 24 and the second lead screw 25 mechanically coupled with each other.

In this embodiment, the first drive mechanism section for driving the first lens group holder 10 and the second drive mechanism section for driving the second lens group holder 11 are formed of identical component parts. Therefore, the description on the drive mechanism sections below will be done only on the first drive mechanism section.

The first motor 22 as the drive source is fixedly mounted to a mounting portion (not shown) erected on the base portion 13, and a stepping motor is used as the motor, for example. Then, a spur gear 26 is provided on an output shaft of the first motor 22, and rotation of the spur gear 26 is transferred via an idle gear 27 to a spur gear 28 formed near an end portion of the first lead screw 23, by which the first lead screw 23 is driven into rotation. That is, the spur gear 26, the idle gear 27 and the spur gear 28 constitute the first gear reduction part. It is noted that the reduction ratio by the first gear reduction part is set to about 2 in this embodiment.

The first lead screw 23, which extends along the lens optical axis direction and which is rotationally driven by the drive source and the first gear reduction part, is rotatably supported by the base portion 13 and a lid portion 29. In this case, with the pitch of the first lead screw 23 set to 0.35 mm and with the drive-source first stepping motor 22 driven by 1-2 phase micro-step drive, the minimum feed resolution per pulse results in about 5 μm. It is noted that the first lead screw 23 is desirably biased in one direction in the axial direction by biasing means formed of an unshown plate spring so that no backlash in the axial direction is involved.

The first nut 16 to be screwed with the first lead screw 23 is made of, for example, a magnetic material formed by plating an SPCC iron sheet with nickel, and removably coupled by attractive force with the magnet 18 provided on the first lens group holder 10 side. It is noted that the first nut 16 has a recessed portion 16a which is to be engaged with the anti-rotation pin 30 erected on the base portion 13 for regulation of its own rotation.

The lens driving unit having the above-described construction operates as follows. That is, FIG. 3 shows a cross section in a use state that the first lens group holder 10 and the second lens group holder 11 are projecting from the lens driving unit body. In the lens driving unit of this embodiment, the effective moving distance of the first lens group holder 10 is set to about 8.5 mm.

In this state, when the first lens group holder 10 has received an impact from external due to a fall or the like, the first lens group holder 10 and the first nut 16 are released from their coupling by the attractive force between the first nut 16 and the magnet 18. Then, whereas the first nut 16 remains in the same position, the first lens group holder 10 travels in the direction opposite to the subject side. As a result, when the cushioning member 20 provided on one side of the first lens group holder 10 opposite to the subject side has come into contact with the second lens group holder 11, the second lens group holder 11 and the second nut 17 are released from their coupling by the attractive force between the second nut 17 and the magnet 19. Then, the second lens group holder 11 travels in the direction opposite to the subject side together with the first lens group holder 10. Thus, it becomes possible for the first lens group holder 10 and the second lens group holder 11, as shown in FIG. 4, to retreat until the cushioning member 21 provided on one side of the second lens group holder 11 opposite to the subject side comes into contract with the subject-side surface of the base portion 13.

More specifically, the lens group holders 10, 11, upon reception of external force, move so as to instantaneously come into a collapsed state, thus capable of relaxing the impact and reducing damage. Further, the cushioning members 20, 21 provided for the lens group holders 10, 11, respectively, have an effect of relaxing the impact due to collisions among component parts within the lens driving unit and thereby reducing damage.

After the lens group holders 10, 11 and the nuts 16, 17 have separated from each other, respectively, the lens group holders 10, 11 are not biased from any other member, coming to a free state, collapsing in an arbitrary position within the travel range and becoming retreatable. Accordingly, damage of not only the coupling portions between the lens group holders 10, 11 and the nuts 16, 17 but also the other portions including the lens barrel portions of the lens group holders 10, 11 can be reduced.

In addition, in the state that the lens group holders 10, 11 and the nuts 16, 17 are separated from each other, respectively, the lens group holders 10, 11 and the nuts 16, 17 can be restored to the original coupling state by the operation that the nuts 16, 17 are driven by the lead screws 23, 25, respectively, to become closer to the lens group holders 10, 11 so that attractive force acts between the nuts 16, 17 and the magnets 18, 19, respectively.

Hereinbelow, the operation of restoration to the original state of the lens group holders 10, 11 and the nuts 16, 17 is explained. It is noted that the lens driving unit is provided with a first initial position sensor and a second initial position sensor (neither shown) for detecting initial positions of the first lens group holder 10 and the second lens group holder 11, respectively. Further, the portable telephone on which the lens driving unit is to be mounted is internally provided with an impact detection sensor (not shown) for detecting an impact force applied to the lens driving unit.

Each of the initial position sensors is formed of, for example, a photo-interrupter and a light-shielding plate. The light-shielding plates are formed so as to be integrated with the lens group holders 10, 11, respectively, while the photo-interrupters are formed at positions which are inside the lens driving unit and which allow the detection to be fulfilled by movement of the light-shielding plates within the movable ranges of the lens group holders 10, 11, respectively. At least when the portable telephone is turned on, the lens group holders 10, 11 move to their home positions on the basis of a detection signal derived from the initial position sensors.

The impact detection sensor is implemented by, for example, an acceleration sensor, and installed within a camera module as this lens driving unit or within the portable telephone on which this camera module is mounted. The impact detection sensor detects any impact force that is larger than a force that cancels the coupling between the lens group holders 10, 11 and the drive mechanism sections by attractive force between the nuts 16, 17 and the magnets 18, 19, respectively, and detects at least an impact force (acceleration) in the optical axis direction (uniaxial) of the lens groups. In addition to this, the constitution may also include an arrangement for detection of biaxial impact forces (acceleration) orthogonal to the optical axis direction.

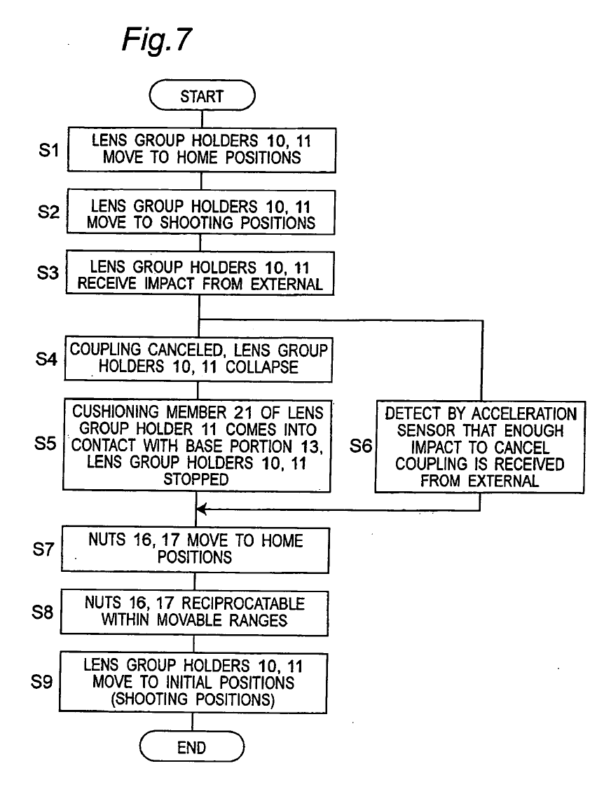

FIG. 7 is a flowchart of lens drive control operation to be executed by control means (not shown) that controls the drive of the stepping motors 22, 24 on the basis of detection signals derived from the initial position sensors and the acceleration sensor. This lens drive control operation includes an operation from the cancellation of the coupling state between the lens group holders 10, 11 and the nuts 16, 17 until the restoration to the original state. Hereinbelow, the operation of the restoration to the coupling state is explained with reference to FIG. 7. When the camera module included in the portable telephone has come into the operation mode, the lens drive control operation starts.

At step S1, the first stepping motor 22 and the second stepping motor 24 are driven on the basis of detection signals derived from the first initial position sensor and the second initial position sensor, so that the first lens group holder 10 and the second lens group holder 11 coupled with the first nut 16 and the second nut 17 are moved to their home positions, respectively. At step S2, the stepping motors 22, 24 are driven so that the lens group holders 10, 11 are moved, generally, to positions that cause a wide shooting state. In addition, the lens group holders 10, 11 are moved according to prescribed step numbers of the stepping motors 22, 24, respectively.

At step S3, during the shooting in the state that the lens group holders 10, 11 are projecting as shown above from the camera module body (a wide shooting state in which the lens group holders 10, 11 are not collapsed), the lens group holders 10, 11 are subject to an impact force from external due to a fall or the like. At step S4, if the impact force is larger than the attractive force of coupling between the lens group holders 10, 11 and the nuts 16, 17, then the coupling between the lens group holders 10, 11 and the nuts 16, 17 by the attractive force is canceled, so that the lens group holders 10, 11 are moved toward within the camera module along the optical axis of the lens groups, thus being collapsed. At step S5, the cushioning member 21 of the lens group holder 11 comes into contact with the base portion 13, by which the impact in the collapsing is absorbed so that the lens group holders 10, 11 are stopped. In this state, the lens group holders 10, 11 are not fixed within the body of the camera module, and so movable in the optical axis direction.

At step S6, a reception of enough impact force to cancel the coupling from external is detected by the acceleration sensor provided within the camera module body or within the portable telephone body, concurrently with step S4 and step S5. At step S7, the stepping motors 22, 24 are driven so that the nuts 16, 17 screwed with the lead screws 23, 25, respectively, are moved and returned to the home positions. In this embodiment, since the drive source is implemented by the stepping motors 22, 24 and since the positions of the nuts 16, 17 upon the impact reception of the lens group holders 10, 11 are stored by step numbers from the home positions, respectively, the nuts 16, 17 can be restored to the home positions irrespective of current detection signals derived from the initial position sensors.

At step S8, because of a possibility that the nuts 16, 17 and the lens group holders 10, 11 may not restore the initial state due to the coupling by the attractive force between the nuts 16, 17 and the magnets 18, 19 in the operation of step S7, the nuts 16, 17 are reciprocated within the movable range (full stroke) of the nuts 16, 17 on the assumption that stop positions of the nuts 16, 17 in above step S7 are taken as reference positions. In this case, since the drive source is implemented by the stepping motors 22, 24 as described above, executing the pulse number control allows the nuts 16, 17 to be controlled for reciprocation within their movable ranges. As a result of the reciprocation operation of the nuts 16, 17 in step S8, it becomes implementable for the lens group holders 10, 11 and the nuts 16, 17 to be necessarily coupled with each other and restored to the original state by the attractive force between the nuts 16, 17 and the magnets 18, 19 even if the lens group holders 10, 11 are stopping at any positions in above step S4.

At step S9, the lens group holders 10, 11 are moved to the initial positions, which correspond to the wide shooting state, according to detection signals derived from the individual initial position sensors. Thereafter, the lens drive control operation is ended.

In this lens drive control operation, when it is detected by the acceleration sensor that enough impact force to cancel the coupling has been received from external, the coupling state restoration is effected. However, the present invention is not limited to this, and it is also possible that a collapsing position sensor for detecting a complete collapse of the lens group holders 10, 11 is further provided so that the restoration to the coupling state can be done on the basis of a detection signal from the acceleration sensor and a detection signal from the collapsing position sensor.

As described above, in this embodiment, the lens group holders 10, 11 and the nuts 16, 17 are coupled with each other, respectively, not by mechanical complete coupling but by coupling using attractive force and allowing the removal. Therefore, even if the axis line of the guide mechanism toward the optical axis direction of the lens group holders 10, 11 and the axis line of the lead screws 23, 25 are shifted from each other so that the coupling surface of the lens group holders 10, 11 with the nuts 16, 17 and the coupling surface of the nuts 16, 17 with the lens group holders 10, 11 are twisted with each other, respectively, it is yet possible to obtain a drivable coupling in the twisted state. Accordingly, the need for assembly with high-accuracy positioning of the individual axis lines is eliminated, hence a high workability of assembly is obtained.

Further, since the lens group holders 10, 11 and the nuts 16, 17 are coupled with each other, respectively, by magnetic attractive force, it becomes possible to make up the lens driving unit with simplicity and low cost by the provision of magnets necessary for attraction on the side of the lens group holders 10, 11 and on the side of the nuts 16, 17, respectively, or by the provision of the magnets on the side of the lens group holders 10, 11 or on the side of the nuts 16, 17 with magnet and magnetic material paired as one set. In this embodiment, the nuts 16, 17 are made of magnetic material. Therefore, by providing the magnets 18, 19 on the side of the lens group holders 10, 11, respectively, the lens driving unit can be made up with the most simplicity and low cost.

Further, mutually opposing surfaces of the lens group holders 10, 11 and the nuts 16, 17 are formed within a plane generally vertical to the optical axis direction of the lens groups, where the nuts 16, 17 are placed on the subject side in the optical axis direction relative to the lens group holders 10, 11. Accordingly, when the lens group holders 10, 11 have received an impact due to a fall or the like from external, the nuts 16, 17 do not move because of the screwing with the lead screws 23, 25, while the lens group holders 10, 11 are separated farther away from the subject side, becoming retreatable. As a result, the lens group holders 10, 11 or the drive mechanism sections can be reduced in the possibility of being damaged.

### Second Embodiment

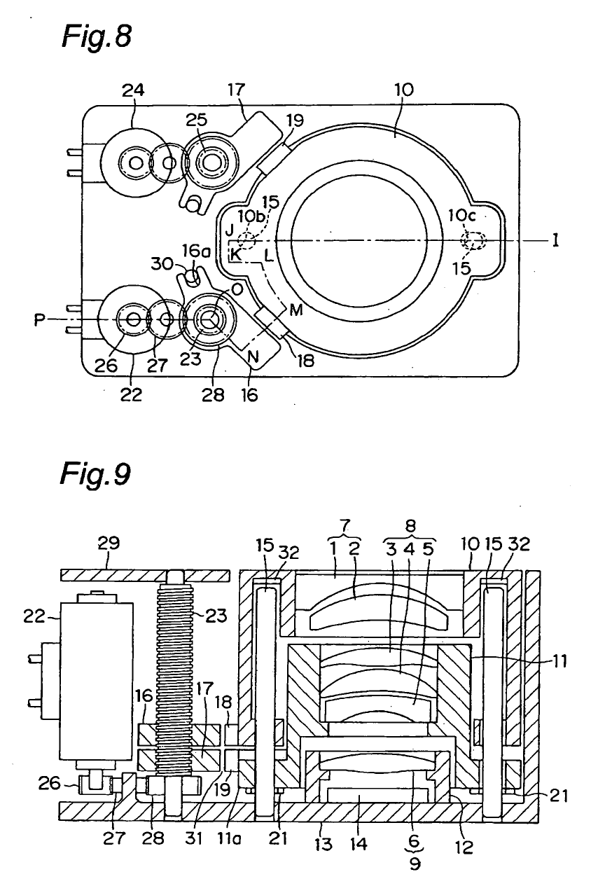

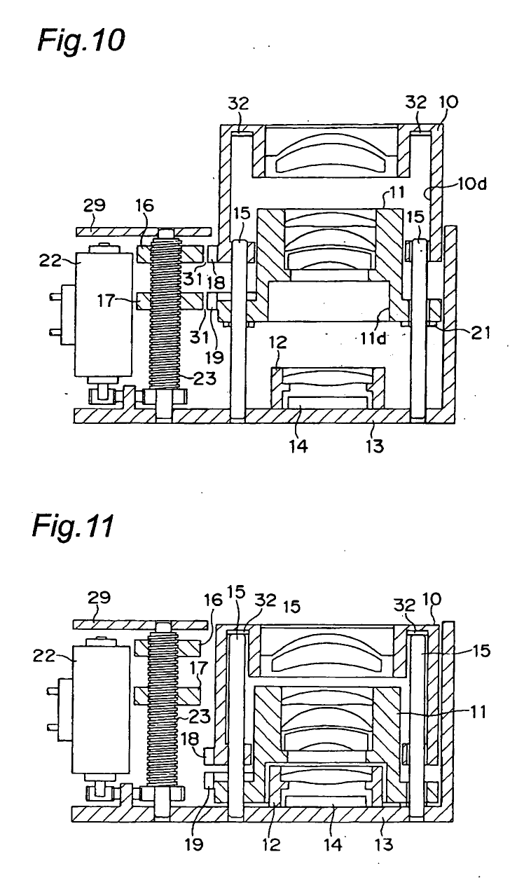

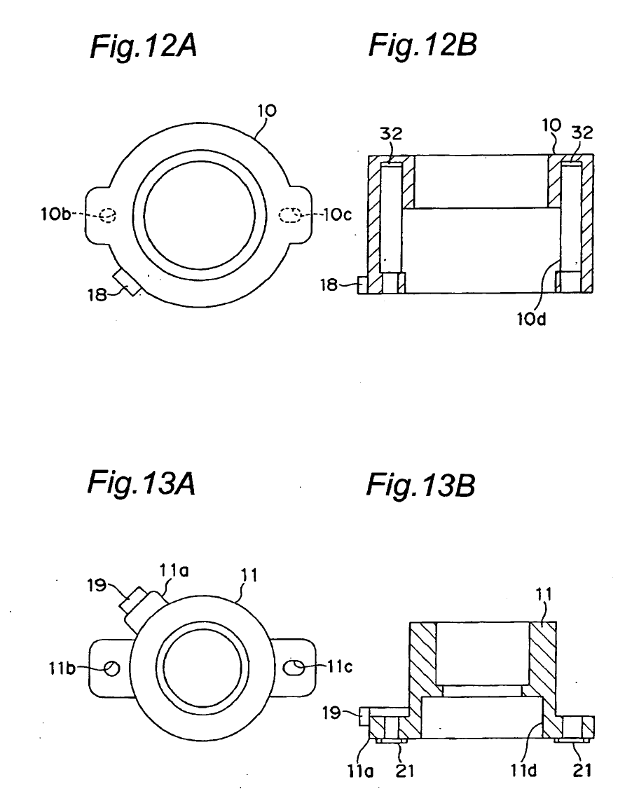

FIG. 8 is a plan view of a lens driving unit according to this embodiment. FIG. 9 is a sectional view at I-P of FIG. 8. FIG. 10 is a sectional view at I-P of FIG. 8 in a state that the lens group holder is projecting from the lens driving unit. FIG. 11 is a sectional view at I-P of FIG. 8 in a state that the lens group holder has collapsed with the lens group holder and the nut separated from each other. FIGS. 12A and 12B are a plan view and a sectional view, respectively, of the first lens group holder. FIGS. 13A and 13B are a plan view and a sectional view, respectively, of the second lens group holder.

In this embodiment, constituent members having the same functions as those of constitute members of the first embodiment are designated by the same reference numerals, and their detailed description is omitted. Hereinbelow, configurations of the first lens group holder 10, the second lens group holder 11, the first nut 16 and the second nut 17 are explained.

The first lens group holder 10, unlike the first lens group holder 10 of the first embodiment, has no protrusions to which the magnet 18 is to be fitted on its outer periphery. The magnet 18 is fixedly fitted by adhesion or the like on the outer side face of the generally cylindrical-shaped first lens group holder 10. The size of the magnet 18 in the optical axis direction is set generally equal to the size of its opposing first nut 16 in the optical axis direction.

In this embodiment, mutually opposing surfaces of the magnet 18 being fixedly fitted to the first lens group holder 10 and the first nut 16, which constitute the coupling portion, are formed within a plane generally parallel to the lens optical axis direction. Therefore, the coupling portion of the first lens group holder 10 and tho coupling portion of the first nut 16 are aligned in a direction generally perpendicular to the optical axis direction, hence not a double structure in the optical axis direction.

In the second lens group holder 11, a protrusion 11a at which the magnet 19 is to be fixedly fitted is provided on its outer periphery. Then, the magnet 19 is fixedly fitted by adhesion or the like on the outer surface of the protrusion 11a. The size of the magnet 19 in the optical axis direction is set generally equal to the size of its opposing second nut 17 in the optical axis direction. Also, mutually opposing surfaces of the magnet 19 being fixedly fitted to the second lens group holder 11 and the second nut 17, which constitute the coupling portion, are formed within a plane generally parallel to the lens optical axis direction. Therefore, the coupling portion of the second lens group holder 11 and the coupling portion of the second nut 17 are aligned in a direction generally perpendicular to the optical axis direction, hence not a double structure in the optical axis direction.

Thus, according to this embodiment, a space saving for the removable coupling portions in the optical axis direction can be achieved, which is effective for miniaturization of the lens driving unit in the optical axis direction.

Further, between mutually opposing surfaces of the first lens group holder 10 and the first nut 16, as well as the second lens group holder 11 and the second nut 17, respectively, gaps 31 are provided. Therefore, when the lens group holders 10, 11 and the nuts 16, 17 are restored to the original state from a mutually separated state, attractive coupling operation can be achieved smoothly without causing their mutual contact.

Furthermore, in the first lens group holder 10, impact-absorbing cushioning members 32 are provided at positions confronting upper end faces of the two guide shafts 15 within the round hole portion 10b and the elongate hole portion 10c, into which the guide shafts 15 are to be inserted, respectively. Thus, an impact-absorbing effect can be produced by the provision of the impact-absorbing cushioning members 32 at either one of the fixing-side members (guide shafts 15) and the sites of contact with the fixing-side members (within the round hole portion 10b and the elongate hole portion 10c).

As described above, in this embodiment, the mutually opposing surfaces of the lens group holders 10, 11 and the nuts 16, 17 are formed on a plane generally parallel to the optical axis direction of the lens groups. Therefore, dissimilar to the first embodiment, there is no need for forming a double structure in the optical axis direction for both contact portions of the lens group holders 10, 11 with the nuts 16, 17 and contact portions of the nuts 16, 17 with the lens group holders 10, 11. Further, it becomes implementable to generate the coupling portions most compactly by an arrangement that the mutually opposing surfaces of the lens group holders 10, 11 and the nuts 16, 17 in the optical axis direction are formed generally equal in length to each other. Thus, a miniaturization of the lens driving unit becomes achievable.

Further, in the foregoing embodiments, the nuts 16, 17 are formed of magnetic material, and the magnets 18, 19 are provided on the side of the lens group holders 10, 11. However, the present invention is not limited to this, and it is also possible that the side of the lens group holders 10, 11 are formed partly of magnetic material while magnets are provided on the side of the nuts 16, 17. It is also possible to provide magnets on both sides of the lens group holders 10, 11 and the nuts 16, 17 to further enhance the attractive force.

Furthermore, in the foregoing embodiments, the lens group holders 10, 11 and the nuts 16, 17 are coupled with each other, respectively, by magnetic attractive force between the nuts 16, 17 and the magnets 18, 19. However, without being limited to magnetic attractive force, the present invention allows the use of means for generating other attractive force such as electrostatic attractive force or electrical attractive force. In brief, the attractive force has only to be one that begins to act as those members approach to a specified distance, then the more they approach, the more the force acts strongly, and that does no longer act as the members are separated from each other to another specified distance. Furthermore, in the foregoing embodiments, although the lead screws 23, 25 and the nuts 16, 17 are used as the feed mechanisms for the lens group holders 10, 11, respectively, yet this is not limitative and it is also allowable to use racks and pinions or linear motors.

It is noted that the terms “generally” in the expressions of “a plane generally perpendicular to the optical axis direction,” “a plane generally parallel to the optical axis direction” and “size . . . generally equal” in the foregoing embodiments implies a consideration of variations in machining precision and means that such errors as can be recognized as “perpendicular”, “parallel” and “equal” by those skilled in the art are permitted.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A lens driving unit comprising:
a lens holder which holds a lens and which is movable in an optical axis direction of the lens;
lens holder driving means which is to be removably coupled with the lens holder by an attractive force that acts in proportion to its distance to the lens holder as the distance to the lens holder becomes smaller than a specified distance, so that the lens holder is translated in the lens optical axis direction, and which is released from coupling with the lens holder by the attractive force when an impact in the optical axis direction is applied to the lens holder in a state of being coupled with the lens holder; and
coupling control means for moving the lens holder driving means, which has been released from the coupling with the lens holder because of the impact, to a position that allows the lens holder driving means to be coupled with the lens holder by the attractive force, and for making the lens holder and the lens holder driving means coupled with each other.

2. The lens driving unit as claimed in claim 1, wherein
the lens holder driving means comprises:
a lead screw which extends in the lens optical axis direction and which has a rotating shaft parallel to the optical axis;
a drive source for driving the lead screw into rotation; and
a nut which is to be screwed with the lead screw and which is regulated for rotation,
wherein the lens holder and the nut have mutually opposing surfaces, and the surface of the lens holder and the surface of the nut are to be removably coupled with each other by the attractive force.

3. The lens driving unit as claimed in claim 1, wherein
the attractive force that causes the lens holder and the lens holder driving means to be coupled with each other is a magnetic attractive force.

4. The lens driving unit as claimed in claim 2, wherein
the nut is made of a magnetic material,
a magnet is provided on a surface of the lens holder opposing the surface of the nut;
the lens holder and the nut are to be removably coupled with each other by a magnetic attractive force.

5. The lens driving unit as claimed in claim 2, wherein
the mutually opposing surfaces of the lens holder and the nut are formed within a plane perpendicular to the lens optical axis direction, and
the nut is placed on a subject side relative to the lens holder in the optical axis direction.

6. The lens driving unit as claimed in claim 2, wherein
the mutually opposing surfaces of the lens holder and the nut are formed within a plane parallel to the lens optical axis direction, and
the surface of the lens holder and the surface of the nut, which are opposing to each other, are generally equal in length in the optical axis direction.

7. The lens driving unit as claimed in claim 6, wherein
the mutually opposing surfaces of the lens holder and the nut are placed with a specified distance therebetween.

8. The lens driving unit as claimed in claim 1, wherein
at a start of an operation mode, the lens holder is moved to a home position by the lens holder driving means while the lens holder and the lens holder driving means are removably coupled with each other by the attractive force,
in a use mode, the lens holder is moved to a use position by the lens holder driving means while the lens holder and the lens holder driving means are removably coupled with each other by the attractive force;
when an impact is applied to the lens holder in the optical axis direction, the lens holder and the lens holder driving means are released from their coupling due to the attractive force, and the lens holder is moved in the optical axis direction so as to come into a collapsed state; and
in a reuse mode, the lens holder driving means is moved by the coupling control means to a position where the lens holder driving means can be coupled with the lens holder by the attractive force, and the lens holder and the lens holder driving means are coupled with each other again.
